(19) United States
(12) Patent Application Publication
(10) Pub. No.: US 2005/0031506 A1
(43) Pub. Date: Feb. 10, 2005

(54) Structure for desulfurizing gasoline or diesel fuel for use in a fuel cell power plant

(76) Inventors: He Huang, Glastonbury, CT (US); Zissis A. Dardas, Worcester, MA (US); Joseph J. Sangiovanni, West Suffield, CT (US)

Correspondence Address: William W. Jones, 6 Juniper Lane, Madson, CT, 06443, US

(21) Appl. No.: 10/635,269

(22) Filed: Aug. 7, 2003

(51) Int. Cl. B01J 8/04

(52) U.S. Cl. 422/211; 422/190

(57) ABSTRACT

A sulfur scrubber structure is operable to remove substantially all of the sulfur present in an undiluted oxygenated hydrocarbon fuel stock supply for a fuel cell power plant assembly which is used to power an engine in a mobile environment, such as an automobile, bus, truck, boat, or the like, or in a stationary environment. The fuel stock can be gasoline, diesel fuel, or other like fuels which contain relatively high levels of organic sulfur compounds such as mercaptans, sulfides, disulfides, and the like. The undiluted hydrocarbon fuel supply is passed through a nickel reactant desulfurizer bed (2) wherein essentially all of the nickel reactant in the scrubber bed reacts with sulfur in the fuel stream, whereby the nickel reactant is converted to nickel sulfide, while the desulfurized organic remnants of the fuel stream continue through the remainder of the fuel processing system. The desulfurizer bed can be formed from a highly porous ceramic or metallic foam monolith, the pores (6) of which are coated with a nickel reactant. The foam monolith can be formed from elemental nickel per se. The use of the high surface area porous foam monolith enables essentially 100% of the nickel reactant to come into contact with the fuel stream being desulfurized.

### TECHNICAL FIELD

The present invention relates to a structure for desulfurizing gasoline, diesel fuel or like hydrocarbon fuel streams so as to render the fuel more suitable for use in a mobil vehicular fuel cell power plant assembly,vas well as conventional IC engines and turbines. More particularly, the desulfurizing structure of this invention is operative to reduce the amount of organic sulfur compounds found in these fuels to levels which will not poison the catalysts in the fuel processing section of the fuel cell power plant assembly and will not harm components of an internal combustion engine. The structure of this invention comprises a nickel reactant bed which has an extended useful life cycle due to the inclusion of a porous open cell monolith which has the nickel reactant deposited thereon.

### BACK GROUND OF THE INVENTION

Gasoline, diesel fuel, and like hydrocarbon fuels have not been useful as a process fuel source suitable for conversion to a hydrogen rich stream for small mobile fuel cell power plants due to the existence of relatively high levels of naturally-occurring complex organic sulfur compounds. Hydrogen generation in the presence of sulfur results in a poisoning effect on all of the catalysts used in the hydrogen generation system in a fuel cell power plant. Conventional fuel processing systems used with stationary fuel cell power plants include a thermal steam reformer, such as that described in U.S. Pat. No. 5,516,344. In such a fuel processing system, sulfur is removed by conventional hydrodesulfurization techniques which typically rely on a certain level of recycle as a source of hydrogen for the process. The recycle hydrogen combines with the organic sulfur compounds to form hydrogen sulfide within a catalytic bed. The hydrogen sulfide is then removed using a zinc oxide bed to form zinc sulfide. The general hydrodesulfurization process is disclosed in detail in U.S. Pat. No. 5,292,428. While this system is effective for use in large stationary applications, it does not readily lend itself to mobile transportation applications because of system size, cost and complexity. Additionally, the fuel gas stream being treated must use large quantities of process recycle in order to provide hydrogen in the gas stream, as noted above.

Other fuel processing systems, such as conventional autothermal reformers, which use a higher operating temperature than conventional thermal steam reformers, can produce a hydrogen-rich gas in the presence of the aforesaid complex organic sulfur compounds without prior desulfurization. When using an autothermal reformer to process raw fuels which contain complex organic sulfur compounds, the result is a loss of autothermal reformer catalyst effectiveness and the requirement of reformer temperatures that are 200° F.-500° F. (93° C.-260° C.) higher than are required with a fuel having less than 0.05 ppm sulfur. Additionally, a decrease in useful catalyst life of the remainder of the fuel processing system occurs with the higher sulfur content fuels. The organic sulfur compounds are converted to hydrogen sulfide as part of the reforming process. The hydrogen sulfide can then be removed using a solid absorbent scrubber, such as an iron or zinc oxide bed to form iron or zinc sulfide. The aforesaid solid scrubber systems are limited, due to thermodynamic considerations, as to their ability to lower sulfur concentrations to non-catalyst degrading levels in the fuel processing components which are located downstream of the reformer, such as in the shift converter, or the like.

Alternatively, the hydrogen sulfide can be removed from the gas stream by passing the gas stream through a liquid scrubber, such as sodium hydroxide, potassium hydroxide, or amines. Liquid scrubbers are large and heavy, and are therefore useful principally only in stationary fuel cell power plants. From the aforesaid, it is apparent that current methods for dealing with the presence of complex organic sulfur compounds in a raw fuel stream for use in a fuel cell power plant require increasing fuel processing system complexity, volume and weight, and are therefore not suitable for use in mobile transportation systems.

An article published in connection with the 21st Annual Power Sources Conference proceedings of May 16-18, 1967, pages 21-26, entitled “Sulfur Removal for Hydrocarbon-Air Systems”, and authored by H. J. Setzer et al, relates to the use of fuel cell power plants for a wide variety of military applications. The article describes the use of high nickel content hydrogenation nickel reactant to remove sulfur from a military fuel called JP-4, which is a jet engine fuel, and is similar to kerosene, so as to render the fuel useful as a hydrogen source for a fuel cell power plant. The systems described in the article operate at relatively high temperatures in the range of 600° F. (316° C.) to 700° F. (371° C.). The article also indicates that the system tested was unable to desulfurize the raw fuel alone, without the addition of large quantities of water or hydrogen, due to reactor carbon plugging. The carbon plugging occurred because the tendency for carbon formation greatly increases in the temperature range between about 550° F. (288° C.) and about 750° F. (399° C.). A system operating in the 600° F. to 700° F. range would be very susceptible to carbon plugging, as was found to be the case in the system described in the article. The addition of either hydrogen or steam reduces the carbon formation tendency by supporting the formation of gaseous carbon compounds thereby limiting carbon deposits which cause the plugging problem.

It would be highly desirable from an environmental standpoint to be able to power electrically driven vehicles, such as an automobile, for example, by means of fuel cell-generated electricity; and to be able to use a fuel such as gasoline, diesel fuel, naphtha, lighter hydrocarbon fuels such as butane, propane, natural gas, or like fuel stocks, as the fuel consumed by the vehicular fuel cell power plant in the production of electricity. In order to provide such a vehicular power source, the amount of sulfur in the processed fuel gas would have to be reduced to and maintained at less than about 0.05 parts per million.

The desulfurized processed fuel stream can be used to power a fuel cell power plant in a mobile environment. The fuel being processed can be gasoline or diesel fuel, or some other fuel which contains relatively high levels of organic sulfur compounds such as thiophenes, mercaptans, sulfides, disulfides, and the like. The fuel stream is passed through a nickel desufurizer bed wherein essentially all of the sulfur in the organic sulfur compounds reacts with the nickel reactant and is converted to nickel sulfide leaving a desulfurized hydrocarbon fuel stream which continues through the remainder of the fuel processing system. U.S. Pat. Nos. 6,129,835, granted Oct. 10, 2000; and 6,156,084, granted Dec. 5, 2000 describe systems for use in desulfurizing a gasoline or diesel fuel stream for use in an internal combustion engine; and a mobile fuel cell vehicular power plant, respectively. The desulfurization beds in the aforesaid systems, both fixed and mobile, would typically utilize alumina pellets which have been admixed with the nickel reactant prior to being formed. Thus the alumina powder and nickel powder are mixed together and the pellets are then formed from the mixture. Using this procedure, a major portion of the nickel reactant ends up in the interior of the pellets, and is therefore unable to contact or be in mass transfer relationship with the fuel stream being desulfurized, and thus is wasted. The use of pelletized desulfurization beds using a nickel reactant is thus inefficient to a certain extent.

U.S. Pat. No. 6,140,266, granted Oct. 31, 2000 describes a compact and light weight catalyst bed which is designed for use with a fuel cell power plant which catalyst bed is useful in a fuel cell power plant reformer assembly. The content of this patent is incorporated into this application in its entirety. The foam support provides a very high surface area bed with excellent flow through characteristics. We have determined that the use of such an open cell foam support would provide a fuel desulfurizing bed that would ensure that essentially 100% of the nickel reactant would be exposed to the fuel stream being desulfurized. Thus, the use of an open cell foam support member in a nickel-based reactant desulfurizing bed would greatly increase the efficiency of the desulfurizer and also increase its useful life. This approach will increase the utilizabon of the Ni-based sulfur adsorbent by at least 3.5 time, i.e., from 20-30% in the pellet form to about 95%. Modeling of this approach has indicated that the useful life of the desulfurizer will be increased at least 2.5 times under normal operating conditions, which is a liquid hourly space velocity of 6 hr⁻¹, at an operating temperature of 375° F. while removing 30 ppm sulfur from the gasoline.

### DISCLOSURE OF THE INVENTION

This invention relates to an improved desulfurizing bed structure for processing a gasoline, diesel, or other hydrocarbon fuel stream over an extended period of time, which structure is operative to remove substantially all of the sulfur present in the fuel stream. The bed structure of this invention includes an open cell foam support member onto which the nickel reactant is deposited. The nickel reactant is deposited in the foam interstices and on all exterior surfaces of the foam. By using a foam support instead of pellets, essentially 100% of the nickel reactant will be able to react with the fuel stream so as to form the nickel sulfide product on the foam support structure.

Gasoline, for example, is a hydrocarbon mixture of paraffins, naphthenes, olefins and aromatics, whose olefinic content is between 1% and 15%, and aromatics between 20% and 40%, with total sulfur in the range of about 20 ppm to about 1,000 ppm. The national average for gasoline in the United States is 350 ppm sulfur. The legally mandated average for the State of California for gasoline is 340 ppm sulfur. The EPA requires that the sulfur level in diesel fuel be reduced to 15 ppm by the end of 2006.

The effectiveness of a nickel adsorbent reactant to adsorb organic sulfur compounds from gasoline depends on the relative coverage of the active reactant sites by adsorption of all the various constituents of gasoline. In other words, the desulfurization process depends on the amount of competitive adsorption of the various constituents of gasoline. From the adsorption theory, it is known that the relative amount of adsorbate on an adsorbent surface depends primarily on the adsorption strength produced by attractive forces between the adsorbate and adsorbent molecules and secondarily on the concentration of the adsorbate in the gasoline, and temperature. Coverage of a reactant surface by an adsorbate increases with increasing attractive forces; higher fuel concentration; and lower temperatures. Relative to gasoline, Somorjai (Introduction to Surface Chemistry and Catalysis, pp, 60-74)provides some relevant information on the adsorption of hydrocarbons on transition metal surfaces, such as nickel. Saturated hydrocarbons only physically adsorb onto the nickel reactant surface at temperatures which are less than 100°F. (38° C.), therefore paraffins, and most likely naphthenes, won't compete with sulfur compounds for adsorption sites on the nickel reactant at temperatures above 250° F. (121° C.) and 300° F. (149° C.).

On the other hand, unsaturated hydrocarbons, such as aromatics and olefins, adsorb largely irreversibly on transition metal surfaces even at room temperature. When an unsaturated hydrocarbon such as an aromatic or an olefin adsorbs on a transition metal surface, and the surface is heated, the adsorbed molecule rather than desorbing intact, decomposes to evolve hydrogen, leaving the surface covered by the partially dehydrogenated fragment, i.,e., tar or coke precursors. At 350° F. (177° C.), unsaturated hydrocarbons are nearly completely dehydrogenated, and the dehydrogenated tar fragments form multiple carbon atom-to-nickel reactant surface bonds. This explains why aromatics and olefins in gasoline, in the absence of oxygenated compounds in appropriate concentrations, will deactivate the nickel reactant from adsorbing sulfur after a relatively short period of time.

Further nonessential but enabling information relating to this invention will become readily apparent to one skilled in the art from the following detailed description of a preferred embodiment of the invention when taken in conjunction with the accompanying drawings in which:

### BRIEF DESCRIPTION OF THE DRAWINGS

These and other objects and advantages of this invention will become readily apparent to one skilled in the art from the following detailed description of a preferred embodiment of the invention when taken in conjunction with the accompanying drawings in which:

FIG. 1 is a perspective view of one form of an open cell foam monolith sulfur scrubber bed formed in accordance with this invention; and

FIG. 2 is a fragmented perspective view of a heat transfer component and foam sulfur scrubber bed assembly which are bonded together;

### SPECIFIC MODE FOR CARRYING OUT THE INVENTION

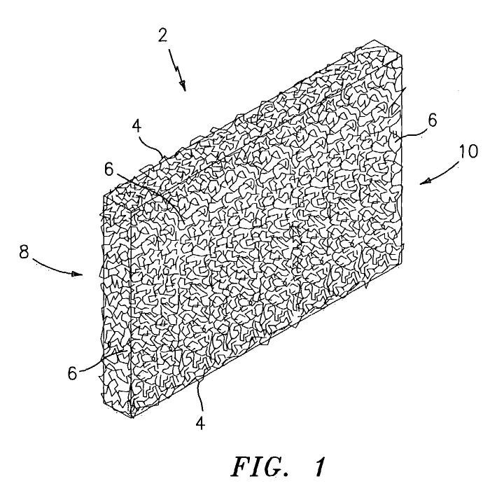

Referring now to the drawings, there is shown in FIG. 1 a perspective view of a rectilinear form of a sulfur scrubber bed formed in accordance with this invention, which bed is denoted generally by the numeral 2. The scrubber bed 2 is a monolithic open cell foam support component which includes a lattice network of tendrils 4 which form a network of open cells 6 which are interconnected in the X, Y and Z directions within the bed 2. The interconnected open cells 6 are operative to form an enhanced fuel gas mixing and distribution flow path from end 8 to end 10 of the bed 2. The open cells 6 and the tendrils 4 also provide a very large nickel reactant-available surface area in the bed 2. The core of the foam scrubber bed 2 can be formed from aluminum, stainless steel, an aluminum-steel alloy, silicon carbide, nickel alloys, carbon, graphite, a ceramic, or the like material.

The bed 2 can be coated with nickel in the following manner. A wash coated porous alumina primer is applied to all outer and interstitial surfaces in the foam core 2 which are to be nickel-coated. The alumina wash coat can be applied to the core 2 by dipping the core 2 into a wash coat solution, or by spraying the wash coat solution onto the core 2. The wash coated core 2 is then heat treated so as to form the alumina layer on the core 2. The nickel layer is then applied to the alumina surfaces of the core 2 in a subsequent wash coating procedure. If so desired, the alumina coating and nickel layer application steps can be performed concurrently. Similar steps could be used with other wash coating materials.

Two separate wash coating approaches can be used in connection with this invention. A first approach is to wash coat the surface of the foam support with the nickel sulfur adsorbent. This approach utilizes a mixture of silica and alumina having a finely dispersed Ni adsorbent which is applied thereto. The silica to alumina ratio is preferably maintained in the range of 2:1 to 3:1. This ratio will provide a desirable support acidity which enhances the ability to the adsorbent to break the organic sulfur modules.

A second wash coating approach is to make the foam support member out of the nickel adsorbent material which is mixed with polypropylene micro spheres and then burning off the polymer particles in a furnace in a controlled atmosphere. This provides a maximum amount of sulfur adsorbent per unit volume of the foam support member. The porosity of the foam can be controlled so that pressure drop is not a problem since a high pressure liquid pump can be used to provide the necessary pressure drop across this foam adsorbent.

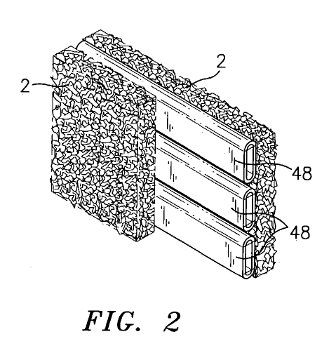

FIG. 2 is a fragmented perspective view showing separate members of the foam components 2 which are bonded to heat transfer components 48. By bonding the open cell foam components 2 to adjacent heat transfer components 48, which can be planar walls, or coolant conduits, continuation of the high thermal conductivity of the foam 2 into the heat transfer component 48 is achieved. The heat transfer components 48 can made of aluminum, stainless steel, steel-based alloys containing aluminum, or high nickel alloys, as dictated by requirements of the system into which the components 2, 48 are incorporated.

The open cell foam bed structure provides improved heat transfer, improved gas flow characteristics, and maximized reactant surface area. The weight and size reductions achieved by using the foam reactant bed construction of this invention are necessary for use in smaller applications such as in mobile vehicles, due to their smaller size and weight. Small size and weight also allow for rapid scrubber bed heat-up to operating temperatures which is a critical requirement for quick start capability necessary in most vehicle applications. The reduced size and weight will also benefit the packaging of stationary power plants. Monolith open cell foam cores of the type described above can be obtained from ERG Energy Research and Generation, Inc. of Oakland, Calif. which cores are sold under the registered trademark “DUOCEL”. Another source of the foam cores is Porvair, Inc., of Ashville, N.C. The use of an open cell foam support for the nickel reactant also ensures that essentially 100% of the reactant will be able to react with sulfur in the fuel stream, and also increases the surface area of the scrubber station as compared to the use of carbon or alumina pellets.

Since many changes and variations of the disclosed embodiments of the invention may be made without departing from the inventive concept, it is not intended to limit the invention other than as required by the appended claims.

1. A sulfur scrubber assembly for removing sulfur from a gasoline or diesel fuel stream so as to reduce the concentration of sulfur in the fuel stream to less than about 0.05 ppm, said assembly comprising:
a) an open cell (6) porous foam support structure (2); and
b) said foam support structure including a nickel reactant on all exposed surfaces of said structure, said nickel reactant being operative to react with sulfur in the fuel stream so as to remove sulfur from the fuel stream and form nickel sulfide deposits on the support structure.

2. The assembly of claim 1 wherein said nickel reactant is in the form of a surface coating on said support structure.

3. The assembly of claim 2 wherein said support structure is formed from alumina.

4. The assembly of claim 1 wherein the foam support structure is formed from nickel.
